(19) United States
(12) Patent Application Publication
(10) Pub. No.: US 2003/0162506 A1
(43) Pub. Date: Aug. 28, 2003

(54) Wireless terminal, wireless base station, wireless communication system, and wireless communication scheme

(75) Inventors: Kiyoshi Toshimitsu, Kanagawa-ken (JP); Hideaki Nakakita, Kanagawa-ken (JP); Kazumi Sato, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/369,721

(22) Filed: Feb. 21, 2003

(30) Foreign Application Priority Data
Feb. 22, 2002 (JP) 2002-046471

(51) Int. Cl. H04B 1/00

(52) U.S. Cl. 455/70; 455/68; 455/552

(57) ABSTRACT

A wireless terminal for performing wireless communication with a wireless base station, comprising: a wireless mode selection unit which selects all combinations between modulation/demodulation schemes and error correction schemes capable of performing wireless communication of predetermined quality with the wireless base station; a wireless mode storage unit which stores all combination information selected by the wireless mode selection unit; and a wireless communication process unit which transmits a specific wireless signal including all combination information between the modulation/demodulation schemes and the error correction schemes stored in the wireless mode storage unit, and a service quality identifier representing quality of a wireless communication service in the case of performing wireless communication with the wireless base station, to the wireless base station.

### CROSS REFDRENCE TO RELATED APPLICATIONS

This application is based upon and claims the benefit of priority from the prior Japanese Patent Applications No. 2002-46471, filed on Feb. 22, 2002, the entire contents of which are incorporated herein by reference.

### BACKGROUND OF THE INVENTION

1. Field of the Invention

The present invention relates to a wireless terminal, a wireless base station, a wireless communication system having a wireless terminal and a wireless base station, and a wireless communication scheme. More specifically, the present invention relates to a data transmission technique which requires real time characteristics.

2. Related Background Art

With the recent development of LAN (Local Area Network) technique, networking has advanced with a central focus on associations between PCs (Personal Computers) in the environments of offices. While such a cable LAN is popularized, a wireless LAN with which a part of a cable LAN is replaced by wireless communication also has advanced. For example, a wireless base station is associated to a cable LAN, and a plurality of mobile PCs are associated to the base station by wireless communication. When a file of a desk-top PC associated to the cable LAN with Ethernet (trademark) is edited through a mobile PC, the mobile PC accesses the cable LAN by wireless communication. The base station and the mobile PCs constitute the wireless LAN. Advantages of such a wireless LAN are that wires need not be laid down because electric waves, infrared waves, or the like are used as a transmission path and that installation of a new network or the layout modification can be easily carried out.

Installation of such wireless LANs is accelerated by the standardization of IEEE802.11. In IEEE802.11, wireless LAN specifications at 2.4-GHz band were completed in 1997, and wireless LAN specifications at 5 GHz were completed in 1999.

The transmission rates of the wireless LAN specification at 2.4 GHz are 1 to 2 Mbps and 11 Mbps. Another specification having a transmission rate which exceeds 20 Mbps is being examined at the present. Nowadays, products implemented in relation to the 2.4-GHz specifications have been sold by various companies, and the prices of base stations and wireless PC cards based on the specifications have been reasonable.

Products based on standards called Bluetooth (trademark) of the 2.4-Ghz standards have been installed in all devices produced by mobile phone industries, home electric industries, and PC industries. Bluetooth is also the wireless system. The Bluetooth systems are expected to be worldwidely popularized for the following reasons. That is, Bluetooth systems have low prices, i.e., about $5 per chip, the Bluetooth standard is approved by about 2000 companies of a broad range of industries, and standard forming action directly coupled with commercialization of product is carried out.

On the other hand, in the wireless LAN specifications at 5-GHz band, a transmission rate of 6 to 54 Mbps can be realized. The 5-GHz band is a frequency band which is approximately unused at the present, as distinct from the 2.4-GHz band. In addition, a higher transmission rate can be easily expected at the 5-GHz band. For this reason, the wireless LAN specifications at 5-GHz band are widely expected as next-generation wireless LAN specifications and specifications for communicating video contents such as TV programs and movies. Some companies will sell products using the wireless LAN specifications at 5-GHz band at a cost of $35 per chip during 2001 year.

Not only in the U.S. (IEEE), as unique standards, the HyperLAN2 standard and the wireless 1394 standard are designed in Europe and Japan, respectively. In these three standards, PHY layers in terms of communication protocols are almost commonly formed, and MAC layers in terms of communication protocols are differently formed. In this manner, the 5-GHz band gradually becomes familiar with the public.

With the above circumstances, the application range of these techniques is considered to spread to not only the environments of offices but also households with popularization of wireless devices. In particular, it may be more attractive at home than in an office that laying of wires is not necessary. From the perspective that video contents can be communicated, it is expected that the needs of houses are higher than those of offices.

However, a wireless LAN standard which is most popular at the present does not comprise a function of transmitting video contents. At the present, the IEEE (U.S.) performs standardization (IEEE802.11e) of MAC layer which satisfies real time characteristics is performed on the basis of MAC specifications of 5-GHz band wireless LAN (IEEE802.11a). However, the standardization will be completed after a lapse of several years. In addition, since the process of IEEE802.11e is complex more than that of IEEE802.11a, the prices may be higher than those of products based on IEEE802.11a, despite the products for family use to which low price is essentially necessary.

A transmission rate which is requested to transmit MPEG2 video data having high quality equal to that of DVD video data is about 6 Mbps at most. A wireless system which can achieve transmission at a high rate of 30 Mbps or more as in IEEE802.11a has potential ability of transmitting high-quality video contents. However, in a best-effort type wireless LAN system such as an IEEE802.11a LAN system, the number of terminals associated to one base station increases. As a result, when a total amount of traffic increases or when data to be transmitted includes a large amount of data for burst transmission, MPEG2 video data is temporarily accumulated in a buffer in MAC. Therefore, the video data cannot be transmitted at a necessary timing. The high-rate transmission at 30 Mbps can be realized only when wireless communication quality is good. When communication quality is poor, the transmission rate decreases. As a result, the MPEG2 video data cannot be transmitted.

The IEEE802.11e system tries to perform priority control or guarantee type control for data transmission to avoid the above problems. Another technical problem that the control is complex is posed.

### SUMMARY OF THE INVENTION

An object of the present invention is to provide a wireless terminal, a wireless base station, a wireless communication system, and a wireless communication scheme which can easily and accurately process an association request from a disassociated wireless terminal while guaranteeing communication quality of an associated wireless terminal.

A wireless terminal for performing wireless communication with a wireless base station, comprising:

a wireless mode selection unit which selects all combinations between modulation/demodulation schemes and error correction schemes capable of performing wireless communication of predetermined quality with the wireless base station;

a wireless mode storage unit which stores all combination information selected by the wireless mode selection unit; and

a wireless communication process unit which transmits a specific wireless signal including all combination information between the modulation/demodulation schemes and the error correction schemes stored in the wireless mode storage unit, and a service quality identifier representing quality of a wireless communication service in the case of performing wireless communication with the wireless base station, to the wireless base station.

### BRIEF DESCRIPTION OF THE DRAWINGS

FIG. 1 is a block diagram showing the entire configuration of a wireless communication system according to the present invention.

FIG. 2 is a block diagram showing an application feature of the present invention at home.

FIG. 3 is a block diagram showing the schematic configuration of a wireless terminal according to one embodiment.

FIG. 4 is a block diagram showing the schematic configuration of a wireless base station according to an embodiment of the present invention.

FIGS. 5A to 5C are diagrams showing an example of a management table.

FIG. 6 is a sequential chart for explaining operations of an association permission/refusal decision unit in detail.

FIG. 7 is a flow chart corresponding to FIG. 6.

FIGS. 8A to 8C are diagrams showing communication bands obtained when an association of address 3 to a wireless terminal is permitted.

FIG. 9 is a sequential chart showing a case in which a wireless terminal receiving a control information frame from a wireless base station communicates with the wireless base station.

FIG. 10 is a flow chart corresponding to FIG. 9.

FIGS. 11A to 11C are diagrams showing an example of a management table provided inside a wireless association terminal management unit.

FIG. 12 is a flow chart showing process operations of an association permission/refusal decision unit in a wireless base station in the second embodiment.

FIGS. 13A to 13C are diagrams showing communication bands in the case where an association to address 3 is permitted.

FIG. 14 is a sequence chart showing a communication procedure between a wireless base station and a wireless terminal in the third embodiment.

FIG. 15 is a sequence chart in the fifth embodiment.

FIG. 16 is a block diagram showing the schematic configuration of a wireless terminal according to the fifth embodiment.

FIG. 17 is a flowchart showing an example of a procedure which measures occupancy of a wireless channel and is performed by the wireless terminal.

### DESCRIPTION OF THE PREFERRED EMBODIMENTS

A wireless terminal, a wireless base station, a wireless communication system, and a wireless communication scheme according to the present invention will be described below with reference to the accompanying drawings.

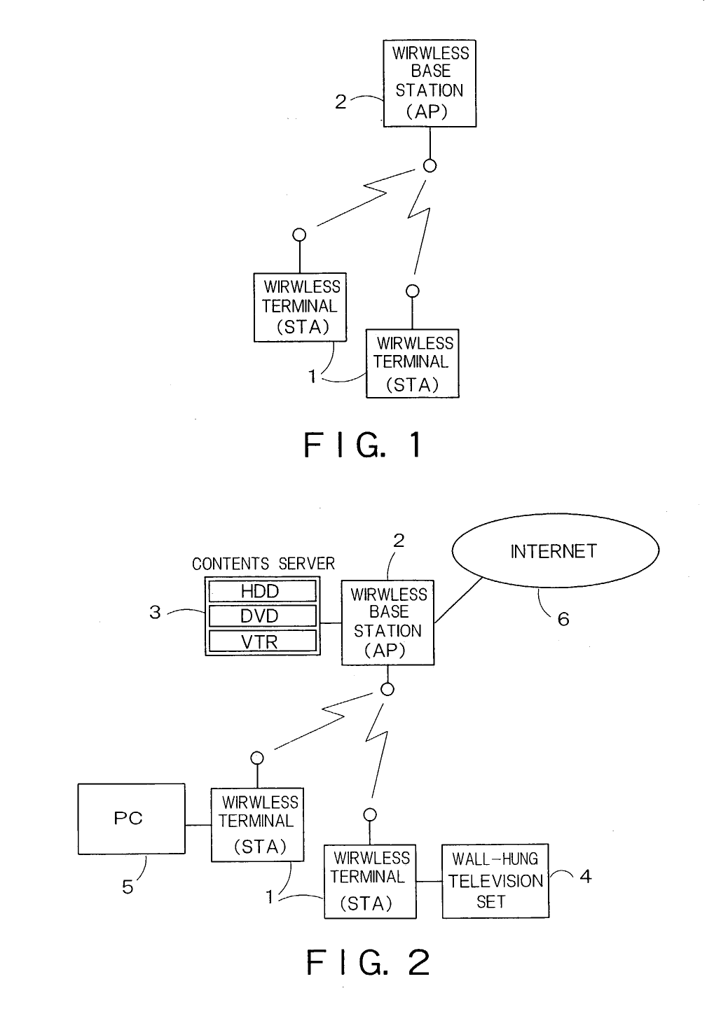

FIG. 1 is an example of a block diagram showing the entire configuration of a wireless communication system according to the present invention. The wireless communication system shown in FIG. 1 has wireless terminals 1 including wireless sending/receiving functions and a wireless base station 2 which can perform wireless communication with the wireless terminals 1. Although FIG. 1 shows an example with which two wireless terminals 1 is provided, the number of wireless terminals 1 is not limited to specific numbers.

When the wireless communication system according to the present invention is used at home, the following features are considered. That is, as shown in FIG. 2, the function of a contents server 3 is given to the wireless base station 2, various display devices such as a wall-hung television set 4 are associated to the wireless terminals 1, and a PC 5 is associated to the wireless terminals 1. The contents server 3 has a reproducing function for a large-capacity hard disk in which contents of many types can be accumulated and various media such as a DVD, a CD, and a video tape. The wireless base station 2 may have a function of connecting the Internet 6 through communication lines such as an ADSL, a CATV, an FTTH line, and an ISDN line and a function of receiving digital broadcast data.

The following description shows an example using IEEE802.11a which is one of wireless LAN specifications in the U.S. as a wireless communication system between the wireless base station 2 and the wireless terminals 1. However, the wireless communication system of the present invention is not limited to IEEE802.11a.

(First Embodiment)

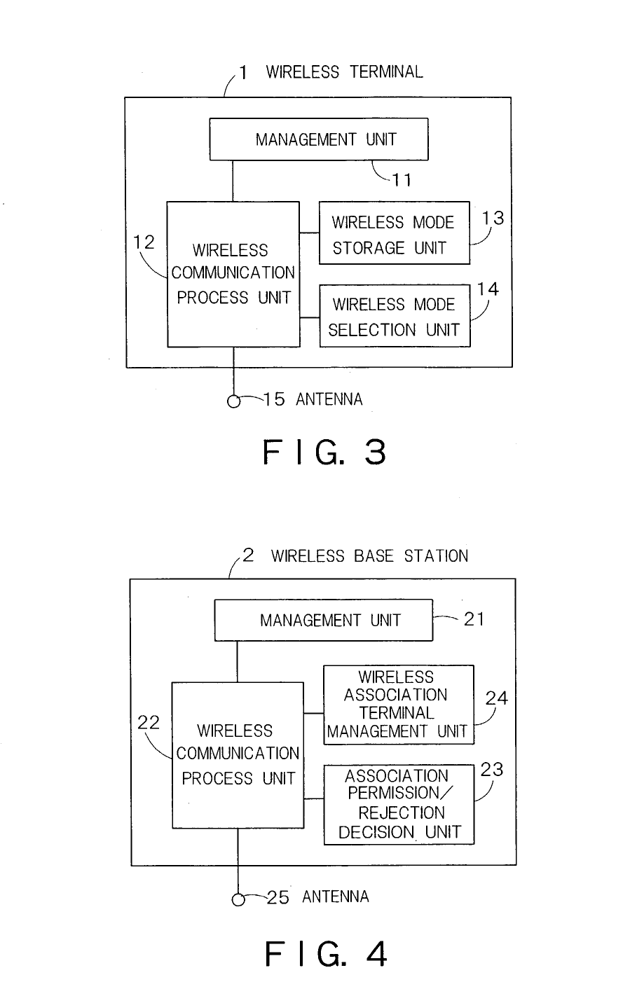

FIG. 3 is a block diagram showing schematic configuration of a wireless terminal 1 of an embodiment according to the present invention. The wireless terminal 1 shown in FIG. 3 has a management unit 11, a wireless communication process unit 12, a wireless mode storage unit 13, a wireless mode selection unit 14, and an antenna 15.

The management unit 11 manages the entire wireless terminal 1. More specifically, the management unit 11 has a function of processing an application such as video contents and an interface function for performing communication with another function block for processing the application.

The wireless communication process unit 12 performs a association/disassociation process to/from the wireless base station 2, wireless access control, a wireless modulation/demodulation process, and a wireless RF process. The wireless communication process unit 12 may perform an authentication process.

The wireless mode selection unit 14 selects a modulation/demodulation scheme or an error correction scheme which can cause the wireless terminal 1 to communicate with the wireless base station 2 depending on reception conditions in the wireless communication process unit. The reception conditions mentioned here include a reception power (RSSI: Received Signal Strength Indicator), a packet error rate (PER), a modulation accuracy, and the like.

For example, in IEEE802.11a, combinations between modulation schemes and error correction schemes which are accepted in communication from the wireless base station 2 to the wireless terminal 1 are 8 types, i.e. (1) BPSK and a code rate of ½; (2) BPSK and a code rate of ¾; (3) QPSK and a code rate of ½; (4) QPSK and a code rate of ¾; (5) 16 QAM and a code rate of ½; (6) 16 QAM and a code rate of ¾; (7) 64 QAM and a code rate of ⅔; and (8) 64 QAM and a code rate of ¾. Transmission rates in wireless regions when these modulation/demodulation schemes and error correction schemes are used are (1) 6 Mbps, (2) 9 Mbps, (3) 12 Mbps, (4) 18 Mbps, (5) 24 Mbps, (6) 36 Mbps, (7) 48 Mbps, and (8) 54 Mbps.

IEEE802.11a uses convolution coding as an error correction scheme, and supports a plurality of code rates. However, in this embodiment, even if the error correction scheme is the same, when the code rates are different from each other, they are assumed as the different correction schemes. As a matter of course, a case in which an RS code and a convolution code use different error correction schemes is included in the spirit and scope of the present invention.

The wireless mode selection unit 14 selects all usable combinations between usable modulation/demodulation schemes and error correction schemes from the combinations (1), (2), (3), (4), (5), (6), (7), and (8) between the modulation schemes and the error correction schemes on the basis of the results obtained by measuring communication quality in the wireless range between the wireless base station 2 and the wireless terminal 1. Hereinafter, an example with which the combinations (1), (2), (3), (4), (5), and (6) are selected will be explained. More specifically, it is assumed that poor wireless communication quality makes it impossible to use the modulation/demodulation schemes and the error correction schemes of the combinations (7) and (8). In this case, combinations of modulation/demodulation schemes and error correction schemes which serve as elements constituting the above-mentioned association request frame are the combinations (1), (2), (3), (4), (5), and (6).

The wireless mode storage unit 13 stores all combination information between modulation/demodulation schemes and error correction schemes selected by wireless mode selection unit 14.

The wireless terminal 1 transmits a association request frame generated by the wireless communication process unit 12 to the wireless base station 2 before the wireless terminal 1 associates with the wireless base station 2. The association request frame includes all combination information between modulation/demodulation schemes and error correction schemes which can be used in communication between the wireless terminal 1 and the wireless base station 2, and a service quality identifier representing the quality of a wireless communication service between the wireless terminal 1 and the wireless base station 2. The service quality identifier is used to perform optimum band allocation depending on an object of communication.

For example, in a communication service to the wireless base station 2, it is assumed that requested quality classes are two classes including Class 1 of best-effort type and Class 2 of MPEG2 and 6 Mbps which require real time characteristics. When the wireless terminal 1 wants to download MPEG2 data at 6 Mbps, the service quality identifier in the association request frame is set as a service quality identifier of Class 2. In this case, MPEG2 and 6 Mbps are used as an example. In addition, the characteristics of traffic which is of a real-time type are combined to a communication band requested for the transmission to constitute a service quality identifier. The number of classes is not limited to two, and may be properly changed. The wireless terminal 1 transmits a association request frame including the above elements. In this manner, a modulation/demodulation scheme, an error correction scheme, and service quality which can be used by the wireless terminal 1 can be noticed to the wireless base station 2.

FIG. 4 is a block diagram showing the schematic configuration of the wireless base station 2 according to an embodiment of the present invention. The wireless base station 2 in FIG. 4 has a management unit 21, a wireless communication process unit 22, a association permission/refusal decision unit 23, a wireless association terminal management unit 24, and an antenna 25.

The management unit 21 manages the wireless base station 2 as a whole. The management unit 21 itself may has the function of the contents server 3 or may has an interface function for performing communication with the external contents server 3.

The wireless communication process unit 22 may perform a basic process of association/disassociation of the wireless terminal 1, wireless access control, a wireless modulation/demodulation process, and the like. The reason why the processes include the basic process of association/disassociation is to remove a association permission/refusal decision process performed by the association permission/refusal decision unit 23. More specifically, the process such as a frame generation process related to association/disassociation is performed by the wireless communication process unit 22, and association permission/refusal is decided by the association permission/refusal decision unit 23.

The association permission/refusal decision unit 23 determines one combination to be actually used from all the combinations of modulation/demodulation schemes and error correction schemes which can be used by the wireless terminal 1, and transmit a association response frame. The detailed operation of the association permission/refusal decision unit 23 will be described later.

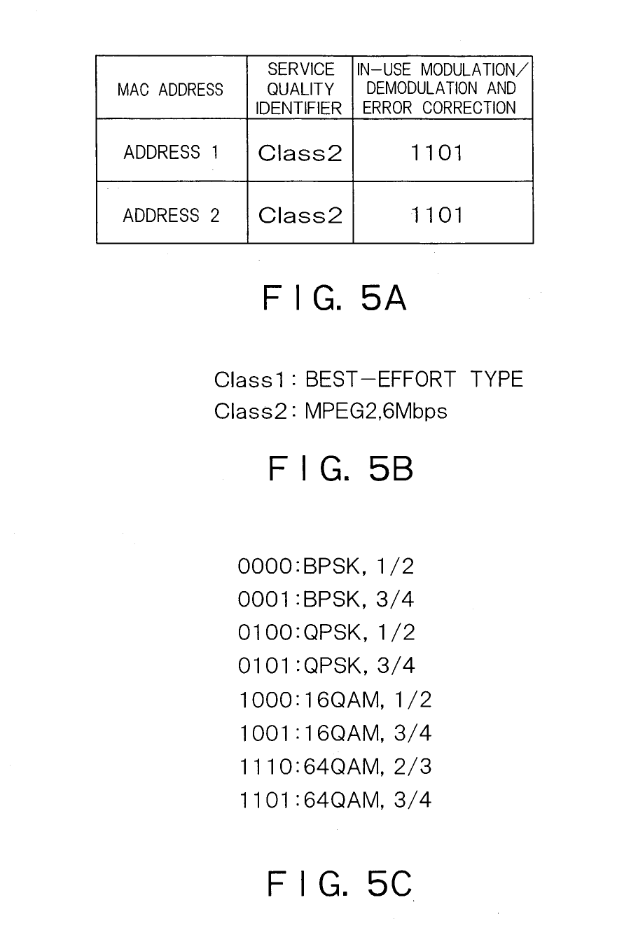

The wireless association terminal management unit 24 manages a specific combination of a modulation/demodulation scheme and an error correction scheme and service quality which are used by the wireless terminal 1 which is permitted to be associated by the association permission/refusal decision unit 23. The wireless association terminal management unit 24 manages the respective wireless terminals 1 by using, e.g., a management table shown in FIG. 5A.

FIG. 5A shows a management table obtained when associations to the two wireless terminals 1 having address 1 and address 2 as MAC (Media Access Control) addresses are permitted. FIG. 5A shows an example in which both the wireless terminals 1 support communication services of MPEG2 and 6 Mbps. In the management table, MAC addresses, service quality identifiers, combination information between modulation/demodulation schemes and error correction information which are being used are registered in units of wireless terminals.

The quality identifiers includes, as shown in FIG. 5B, two types of quality identifiers of Class 1 representing a best-effort type and Class 2 of MPEG2 and 6 Mbps. The information for modulation/demodulation and error correction is expressed by, e.g., 4-digit numbers, and each 4-digit number shows modulation/demodulation and error correction schemes as shown in FIG. 5C.

In the example shown in FIG. 5A, the wireless terminal 1 of Address 1 performs communication by (8) 64 QAM at a code rate of ¾. The wireless terminal 1 of Address 2 performs communication by (8) 64 QAM at a code rate of ¾.

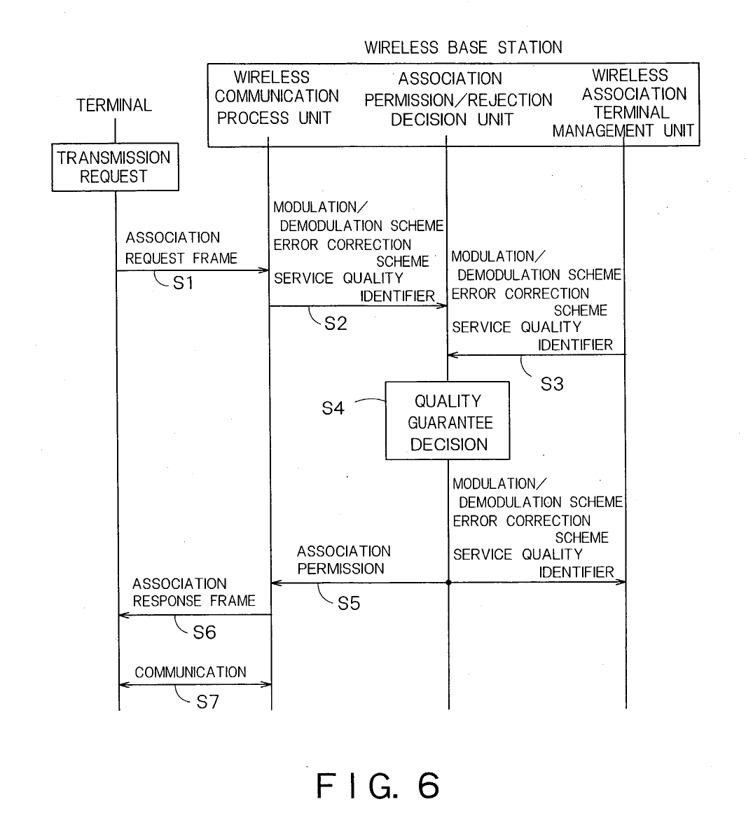

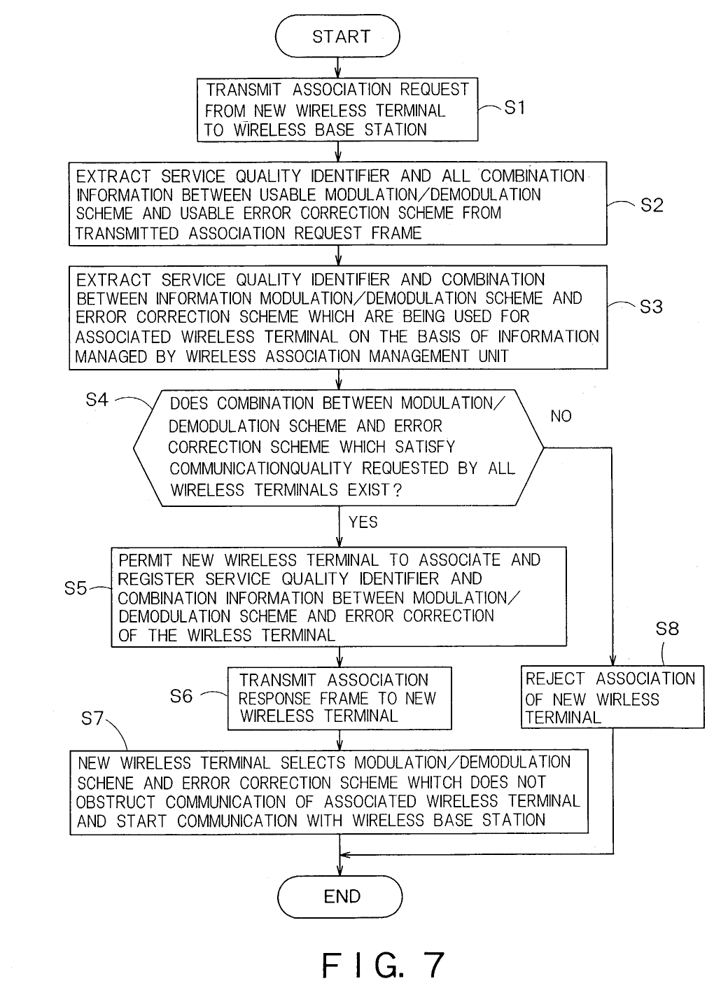

FIG. 6 is a sequence chart showing a procedure in the wireless base station 2 according to the first embodiment. More specifically, FIG. 6 is a sequence chart for exactly explaining an operation of the association permission/refusal decision unit 23. FIG. 7 is a flow chart corresponding to FIG. 6. When a new wireless terminal 1 (to be referred to as Address 3 hereinafter) transmits a association request frame to the wireless base station 2 (step S1), the association permission/refusal decision unit 23 in the wireless base station 2 extracts from the transmitted association request frame, all a service quality identifier and combination information between a usable modulation/demodulation scheme and a usable error correction scheme (step S2). With respect to the modulation/demodulation scheme and the error correction scheme which are used to transmit the association request frame, for example, the wireless terminal 1 which receives a signal transmitted from the wireless base station 2 decides a usable modulation/demodulation scheme and a usable error correction scheme (to be described later), and the most efficient scheme of these schemes may be used. The present invention is not limited to this concrete scheme.

For example, the following case will be described below. That is, the service quality identifier of the wireless terminal 1 of Address 3 is of Class 2, and usable modulation/demodulation schemes and usable modulation/demodulation schemes are (1) BPSK and a code rate of ½, (2) BPSK and a code rate of ¾, (3) QPSK and a code rate of ½, (4) QPSK and a code rate of ¾, (5) 16 QAM and a code rate of ½, (6) 16 QAM and a code rate of ¾, (7) 64 QAM and a code rate of ⅔, and (8) 64 QAM and a code rate of ¾.

The association permission/refusal decision unit 23 extracts service quality identifiers of the associated wireless terminals 1 and combination information between usable modulation/demodulation schemes and error correction schemes on the basis of information managed by the management unit 21 (step S3).

When the association permission/refusal decision unit 23 permits association of the wireless terminal 1 of Address 3, the association permission/refusal decision unit 23 decides whether or not a combination between a modulation/demodulation scheme and an error correction scheme which satisfy communication quality requested by all the wireless terminals 1 of Addresses 1 to 3 exist (step S4). More specifically, the association permission/refusal decision unit 23 decides a modulation/demodulation scheme and an error correction scheme which are preferably used by the wireless terminal 1 of Address 3.

As a result, when a combination of a modulation/demodulation scheme and an error correction scheme which can guarantee communication quality requested by the wireless terminal 1 of Address 3 is found while guaranteeing the communication qualities of the wireless base stations 2 of Addresses 1 and 2 which have been permitted to be associated, a association of the wireless terminal 1 of Address 3 is permitted, and the service quality identification of Address 3 and the combination information between the modulation/demodulation scheme and the error correction scheme are registered in the wireless association terminal management unit 24 (step S5). Thereafter, a association response frame is transmitted to the wireless terminal 1 of Address 3 (step S6).

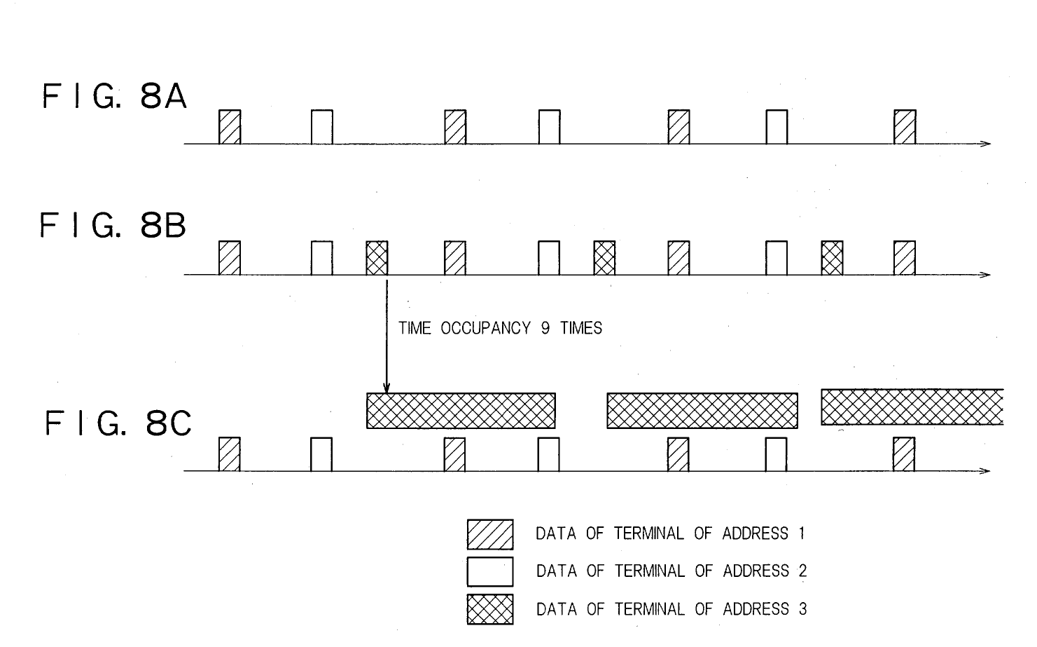

For example, it is assumed that all the wireless terminals 1 of Addresses 1 to 3 request transmission of MPEG2 for performing periodical data transmission. In this case, in order to accommodate these wireless terminals 1, when a total throughput provided by the wireless base station 2 is a throughput which sufficiently exceeds a transmission rate at which three data of MPEG2 can sufficiently transmit at 6 Mbps, i.e., 6 Mbps×3=18 Mbps, communication qualities requested by the respective wireless terminals 1 are satisfied. Therefore, the wireless base station 2 permits the wireless terminal 1 of Address 3 to be associated to the wireless base station 2. In response to this permission, when the wireless terminal 1 of Address 3 performs communication by (8) 64 QAM at a code rate of ¾, a time occupancy in a communication band of each of the wireless terminals 1 is changed from the time occupancy in FIG. 8A to the time occupancy in FIG. 8B, and communication qualities of the three wireless terminals 1 can be guaranteed.

When the wireless terminal 1 of Address 3 receives a association response frame from the wireless base station 2, the wireless terminal 1 selects a modulation/demodulation and error correction schemes which can guarantee the communication quality of the associated wireless terminal 1 to perform communication (step S7). For example, when the radio base station transmits a association response frame by using the modulation/demodulation and error correction schemes decided in step S4, the wireless terminal 1 transmits various frames (including data frames) by using the same modulation/demodulation and error correction schemes as those of the received association response frame. In this manner, the communication quality of the wireless terminal 1 which has been associated to the wireless base station 2 can be guaranteed.

On the other hand, in step S4 in FIG. 7, when the association of the wireless terminal 1 of Address 3 is permitted, and when communication qualities requested by the wireless terminals 1 of Addresses 1 and 2 which have been permitted to be associated cannot be guaranteed, association to the wireless terminal 1 of Address 3 is refused (step S8).

For example, it is assumed that a usable modulation/demodulation scheme and a usable error correction scheme extracted from the association request frame of the wireless terminal 1 of Address 3 are only (1) BPSK and a code rate of ½. In this case, when the wireless terminal 1 of Address 3 is permitted to be associated, a time occupancy of the wireless terminal 1 of Address 3 is large. For this reason, transmission is performed in the manner shown in FIG. 8C. In this case, the communication qualities of the wireless terminals 1 of Addresses 1 and 2 cannot be guaranteed. Similarly, since the communication quality of the wireless terminal 1 of Address 3 cannot be guaranteed, the association permission/refusal decision unit 23 rejects a association request of the wireless terminal 1 of Address 3.

The wireless base station 2 may transmit a control information frame to a wireless terminal in a communication range of the wireless base station 2 by a beacon. In this case, only the wireless terminal 1 which receives the control information frame may request association to the wireless base station 2.

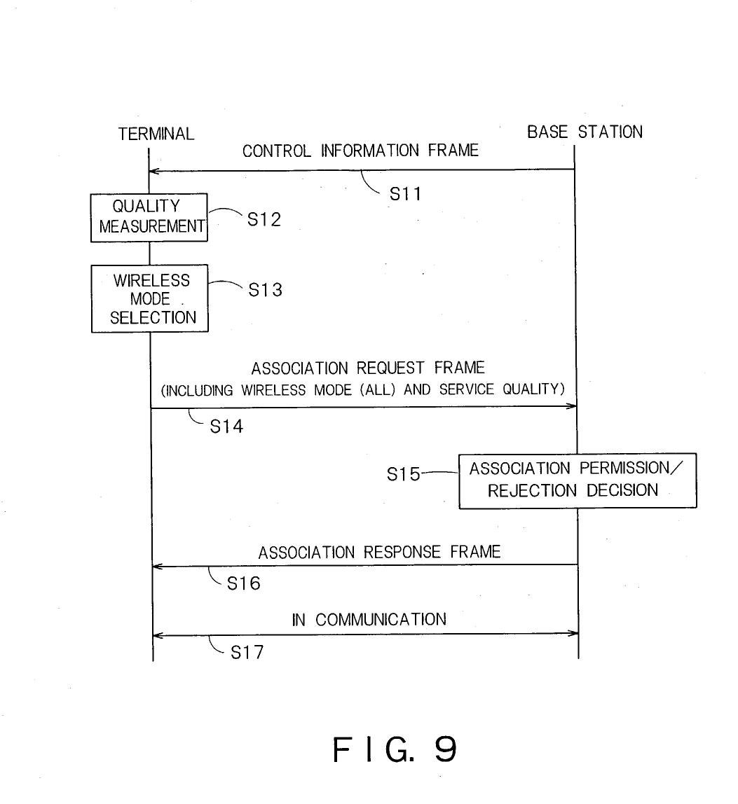

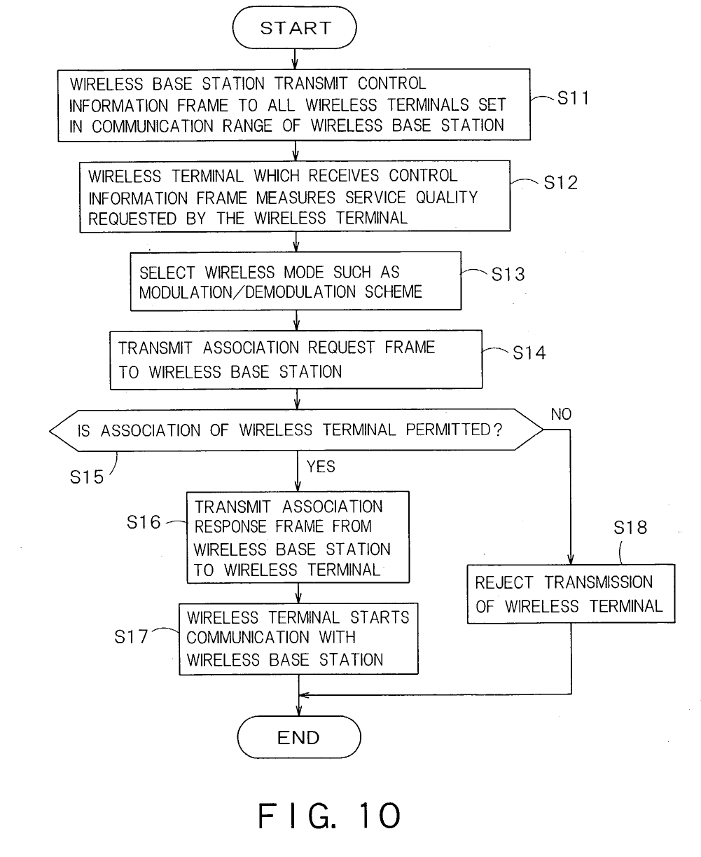

FIG. 9 is a sequence chart showing a procedure between the wireless base station 2 and the wireless terminal 1 in the first embodiment. More specifically, FIG. 9 is a sequence chart obtained when the wireless terminal 1 which has received the control information frame from the wireless base station 2 communicates with the wireless base station 2, and FIG. 10 is a flow chart corresponding to FIG. 9.

The wireless base station 2 transmits control information frames to all the wireless terminals 1 within the communication range of the wireless base station 2 (step S11). The control information frame is a Beacon frame or a Probe Response frame.

After the wireless terminal 1 which receives the control information frame measures service quality requested by itself (step S12), the wireless terminal 1 selects a wireless mode such as a modulation/demodulation scheme (step S13). Subsequently, the wireless terminal 1 transmits a association request frame to the wireless base station 2 (step S14). This association request frame includes all wireless modes and service quality information selected in step S12. In a loaming state, all the wireless modes and service quality information selected in step S13 are added to a Reassociation request frame. A association response frame is a association Response frame or a Reassociation Response frame.

The wireless base station 2 which receives the association request frame decides whether association is permitted or refused by the same procedure as in step S4 in FIG. 7 (step S15). When it is decided that the association is permitted, the wireless base station 2 transmits a association response frame to the wireless terminal 1 (step S16). The wireless terminal 1 which receives the association response frame communicates with the wireless base station 2 (step S17). On the other hand, when it is decided that the association cannot be performed, the wireless base station 2 rejects the association request of the wireless terminal 1 which transmits the association request frame (step S18).

In FIGS. 9 and 10, a transmission/reception process of a frame related to an authentication process is omitted. In FIGS. 9 and 10, a frame based on IEEE802.11 is exemplified. However, the present invention is not limited to IEEE802.11.

As described above, in the first embodiment, when the wireless terminal 1 requests association to the wireless base station 2, the wireless terminal 1 notices usable service quality identifiers and all combination information of usable modulation/demodulation schemes and error correction schemes to the wireless base station 2. Because of this, the wireless base station 2 can easily and accurately decide whether the association of the wireless terminal 1 is permitted or rejected. More specifically, only when the communication quality of another wireless terminal 1 which has been associated to the wireless base station 2 can be guaranteed, a new wireless terminal 1 can be permitted to be associated, and the communication quality can be prevented from being temporarily deteriorated.

In this manner, by using a baseband LSI (IEEE 802.11a standard) or the like which starts to appear in the market at the present and which is expected to be reduced in price at the earliest time, the same effect as that of a baseband LSI which perform priority control and band guarantee control as in IEEE802.11e can be obtained.

According to this embodiment, even in a wireless system using a wireless LAN type baseband LSI which does not perform priority control and band guarantee control, wireless transmission of data such as video contents which require real time characteristics can be realized at low cost.

(Second Embodiment)

The second embodiment is different from the first embodiment in an operation of the wireless association terminal management unit 24 in the wireless base station 2.

The wireless association terminal management unit 24 according to the second embodiment manages combinations of all modulation/demodulation schemes and all error correction schemes which can be used by the wireless terminal 1 which is permitted to be associated by the association permission/refusal decision unit 23, service quality, and a combination of a modulation/demodulation scheme and an error correction scheme which are actually used.

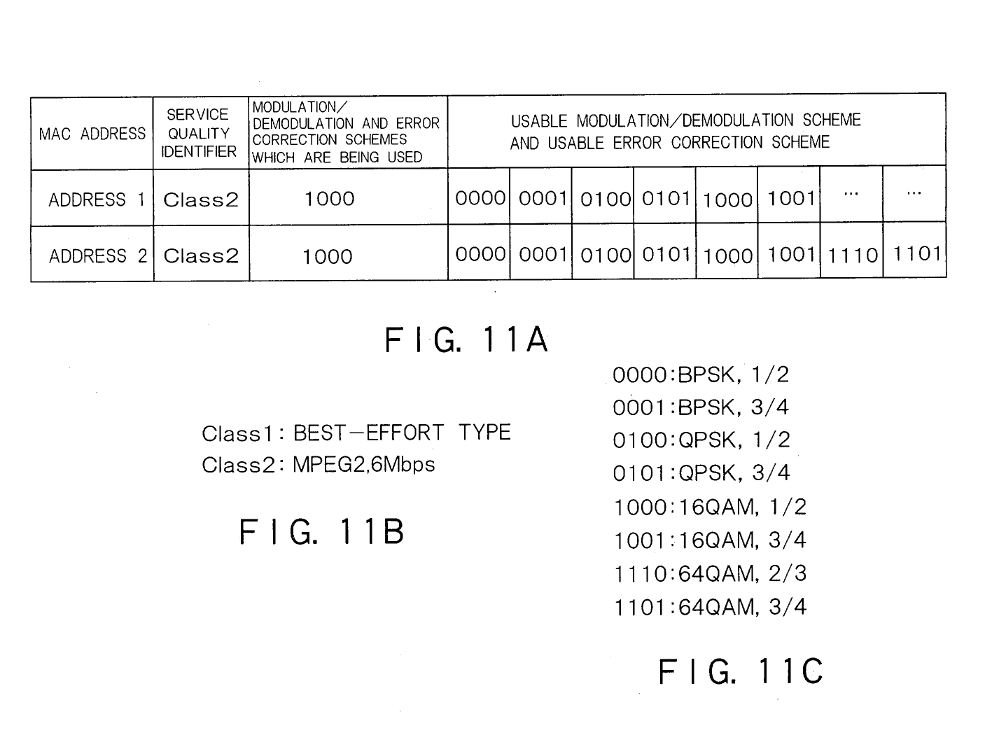

FIG. 11 is a diagram showing an example of a management table set inside the wireless association terminal management unit 24. FIG. 11 shows a table obtained when two wireless terminals 1 having Addresses 1 and 2 as MAC addresses are permitted to be associated. FIG. 11 shows an example in which the wireless terminals 1 support communication services of MPEG2 and 6 Mbps.

The management table in FIG. 11 is compared with that in FIG. 5. In the management table in FIG. 11, all the usable modulation/demodulation schemes and all the usable error correction schemes are registered.

In the management table, the wireless terminal 1 of Address 1 can perform communication by combinations: (1) BPSK and a code rate of ½; (2) BPSK and a code rate of ¾; (3) QPSK and a code rate of ½; (4) QPSK and a code rate of ¾; (5) 16 QAM and a code rate of ½; and (6) 16 QAM and a code rate of ¾. The wireless terminal 1 actually performs communication by the combination (5) 16 QAM and a code rate of ½.

Similarly, the wireless terminal 1 of Address 2 can perform communication by combinations: (1) BPSK and a code rate of ½; (2) BPSK and a code rate of ¾; (3) QPSK and a code rate of ½; (4) QPSK and a code rate of ¾; (5) 16 QAM and a code rate of ½; (6) 16 QAM and a code rate of ¾; (7) 64 QAM and a code rate of ⅔; and (8) 64 QAM and a code rate of ¾. The wireless terminal 1 actually performs communication by using the combination (5) 16 QAM and a code rate of ½.

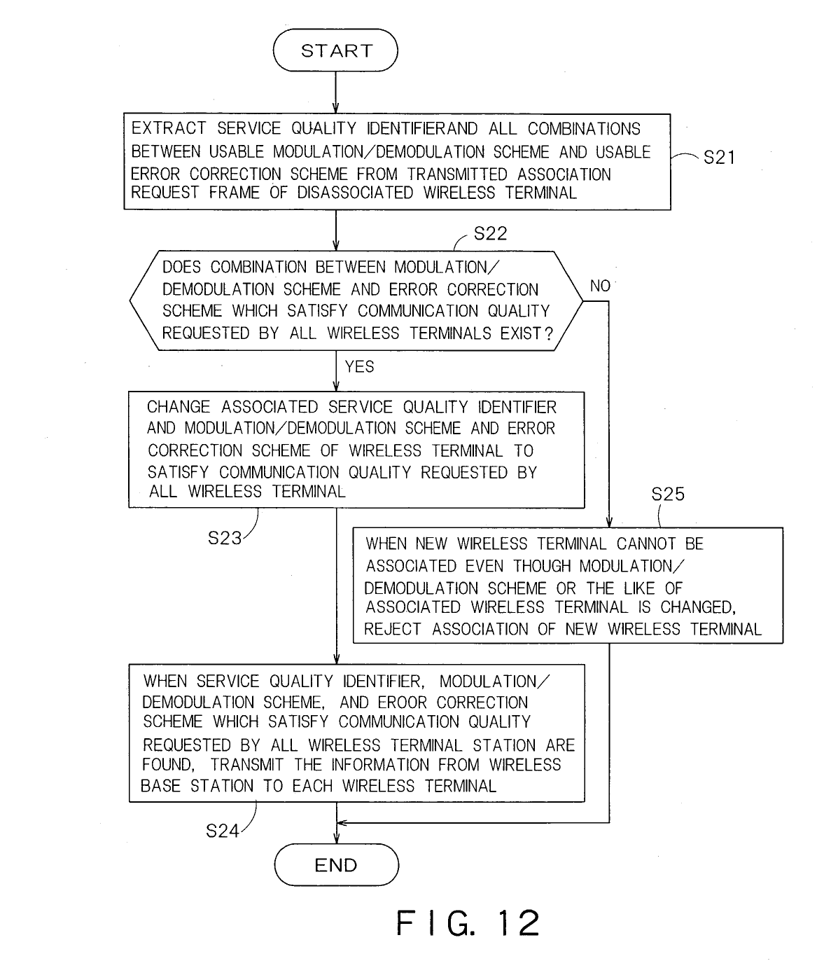

FIG. 12 is a flow chart showing process operations of the association permission/refusal decision unit 23 in the wireless base station 2 according to the second embodiment.

The association permission/refusal decision unit 23 extracts a service quality identifier and all combinations between usable modulation/demodulation schemes and usable error correction schemes from a association request frame of a disassociated wireless terminal 1 (Address 3) (step S21).

For example, the following case will be described below. That is, the service quality identifier of the wireless terminal 1 of Address 3 is of Class 2, and usable modulation/demodulation schemes and usable modulation/demodulation schemes are (1) BPSK and a code rate of ½, (2) BPSK and a code rate of ¾, (3) QPSK and a code rate of ½, (4) QPSK and a code rate of ¾, (5) 16 QAM and a code rate of ½, (6) 16 QAM and a code rate of ¾, (7) 64 QAM and a code rate of ⅔, and (8) 64 QAM and a code rate of ¾.

In the step S21, the association permission/refusal decision unit 23 extracts the service quality identifier of the associated wireless terminal 1 and all usable modulation/demodulation schemes and all usable error correction schemes on the basis of the management table in FIG. 11.

When the association permission/refusal decision unit 23 permits association of the wireless terminal 1 of Address 3, the association permission/refusal decision unit 23 decides whether or not a combination between a modulation/demodulation scheme and an error correction scheme which satisfy communication quality requested by all the wireless terminals 1 of Addresses 1 to 3 exist (step S22). In order to accommodate three wireless terminals 1, a combination having a throughput of 18 Mbps or more can satisfy the communication quality requested by the wireless terminals 1. This is because MPEG2 performs periodical data transmission.

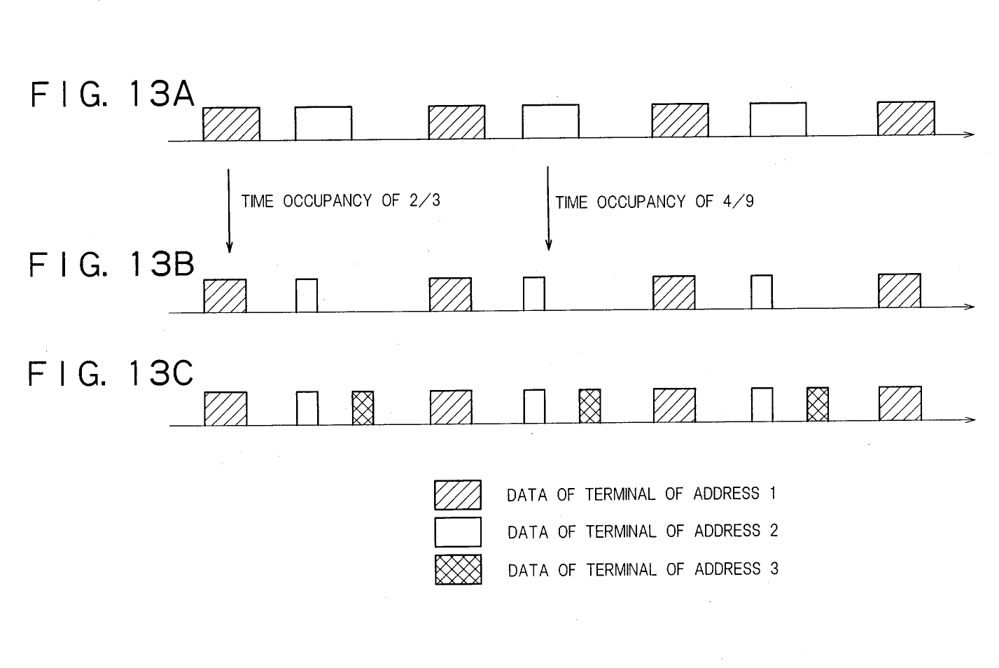

It is assumed that the wireless terminals 1 of Addresses 1 and 2 use the combination of (5) 16 QAM and a code rate of ½ (corresponding to a wireless transmission rate of 24 Mbps) to perform MPEG transmission at 6 Mbps. A transmission condition in the wireless communication range at this time is shown in FIG. 13A. In this condition, when association of the wireless terminal 1 of Address 3 is permitted, the communication qualities of the wireless terminals 1 of Addresses 1 and 2 may not be able to be guaranteed.

In such a case, the service quality identifier of the associated wireless terminal 1 and the modulation/demodulation scheme and the error correction scheme of the wireless terminal 1 are changed to satisfy communication qualities requested by all the wireless terminals 1 (step S23).

For example, in FIG. 13A, when modulation/demodulation schemes and code rates which can be used by the wireless terminals 1 of Addresses 1 to 3 are examined, it is considered that the wireless terminal 1 of Address 1 can use (6) 16 QAM and a code rate of ¾ (corresponding to 36 Mbps) and the wireless terminals 1 of Addresses 2 and 3 can use (8) 64 QAM and a code rate of ¾ (corresponding to 54 Mbps). More specifically, when the modulation/demodulation schemes and the code rates of the wireless terminals 1 of Addresses 1 and 2 are changed, FIG. 13A is changed into FIG. 13. In this state, when the wireless terminal 1 of Address 3 is permitted to be associated by using (8) 64 QAM and a code rate of ¾ (corresponding to 54 Mbps), as shown in FIG. 13C, the communication qualities of all the wireless terminals 1 can be guaranteed.

When a service quality identifier, a modulation/demodulation scheme, and an error correction scheme which satisfy communication quality requested by all the wireless terminals 1 are found, these pieces of information are transmitted from the wireless base station 2 to the respective wireless terminals 1 (step S24). Because the process of step S24 is not absolutely imperative, the process may be omitted.

On the other hand, in step S22, when the wireless terminal 1 of Address 3 cannot be associated even though the modulation/demodulation schemes of the associated wireless terminals 1 of Addresses 1 and 2 are changed, association of the wireless terminal 1 of Address 3 is rejected (step S25).

In this manner, according to the second embodiment, since all the modulation/demodulation schemes and the error correction schemes which can be used by the respective wireless terminals 1 are managed by the wireless association terminal management unit 24 in the wireless base station 2, the modulation/demodulation scheme and the error correction scheme of the associated wireless terminal 1 can be changed when a new wireless terminal 1 requests association. Therefore, the number of wireless terminals 1 to be associated at once can be increased while guaranteeing the communication qualities of the respective wireless terminals 1.

(Third Embodiment)

In the third embodiment, a service quality identifier and combination information between a modulation/demodulation scheme and an error correction scheme which should be selected by a wireless terminal 1 is included in a association response frame which is transmitted from the wireless base station 2 to a wireless terminal 1 which makes a association request.

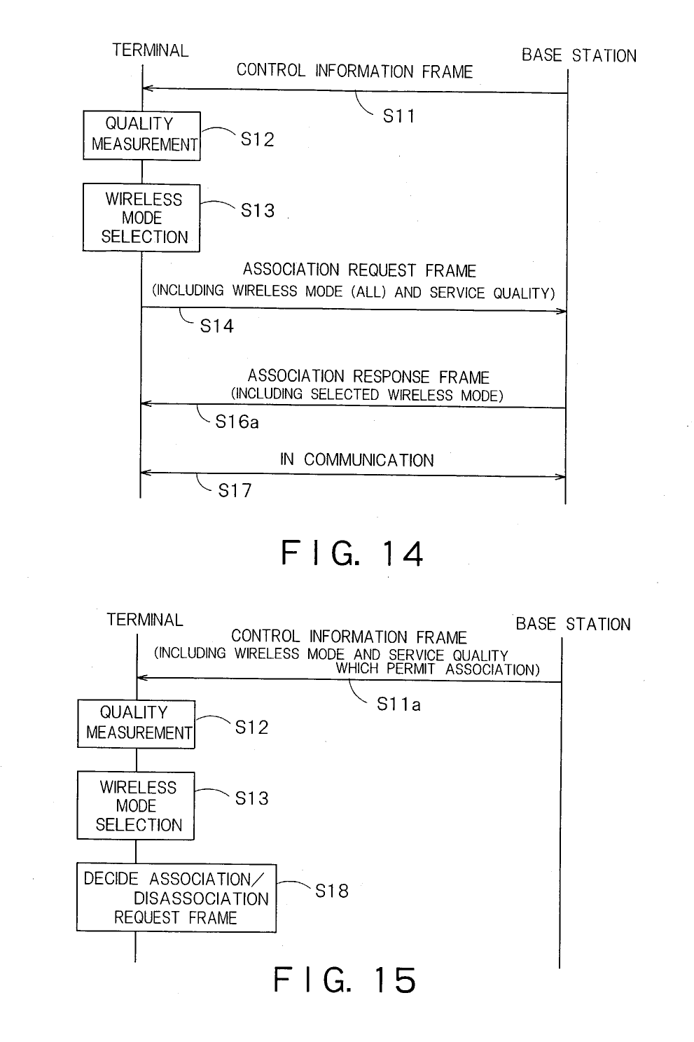

FIG. 14 is a sequence chart showing a communication procedure between the wireless base station 2 and the wireless terminal 1 in the third embodiment. FIG. 14 is different from FIG. 9 in that a association response frame transmitted from the wireless base station 2 to the wireless terminal 1 includes information related to one modulation/demodulation scheme and one error correction scheme which should be selected by the wireless terminal 1 (step S16a).

In the third embodiment, since a modulation/demodulation scheme and an error correction scheme which should be used when the wireless terminal 1 transmits a wireless signal to the wireless base station 2 is designated by the wireless base station 2, the communication qualities of the respective wireless terminals 1 can be reliably guaranteed.

Similarly, a modulation/demodulation scheme and an error correction scheme which should be used when the wireless base station 2 transmits a wireless signal to the wireless terminal 1 may be noticed to the wireless terminal 1 with an association response frame.

A service quality identifier may be added to an association response frame to explicitly notice permitted service quality to the wireless terminal 1.

In addition to one combination between a modulation/demodulation scheme and an error correction scheme to be used, all combinations between modulation/demodulation schemes and error correction schemes which can be used may be included in constituent elements of a association response frame. In this case, the combinations between modulation/demodulation schemes and error correction schemes which can be used are as follows.

It is assumed that combination information between modulation/demodulation schemes and error correction schemes which are transmitted by the wireless terminal 1 with a association request frame includes: (1) BPSK and a code rate of ½; (2) BPSK and a code rate of ¾; (3) QPSK and a code rate of ½; (4) QPSK and a code rate of ¾; (5) 16 QAM and a code rate of ½; (6) 16 QAM and a code rate of ¾; (7) 64 QAM and a code rate of ⅔; and (8) 64 QAM and a code rate of ¾. It is assumed that a specific combination between a modulation/demodulation scheme and an error correction scheme selected by the wireless base station 2 is (6) 16 QAM and a code rate of ¾. In this case, if (7) 64 QAM and a code rate of ⅔ or (8) 64 QAM and a code rate of ¾ which has a low time occupancy is selected, the communication quality of the wireless terminal 1 can be guaranteed. For this reason, the wireless base station 2 notices (6) 16 QAM and a code rate of 3/4, (7) 64 QAM and a code rate of ⅔, and (8) 64 QAM and a code rate of ¾ as combinations between modulation/demodulation schemes and error correction schemes which can be used to the wireless terminal 1 with a association response frame to charge the wireless terminal 1 to select a combination of a modulation/demodulation scheme and an error correction scheme to be used. In this case, the wireless terminal 1 selects a modulation/demodulation scheme and an error correction scheme to be used by a decision made by the wireless terminal 1.

In this manner, according to the third embodiment, since the wireless terminal 1 communicates with the wireless base station 2 by using a service quality identifier, a modulation/demodulation scheme, and an error correction scheme which are included in a association response frame transmitted from the wireless base station 2, the wireless terminal 1 need not select a wireless mode, and the wireless terminal 1 can perform communication having optimum communication quality recommended by the wireless base station 2.

(Fourth Embodiment)

According to the fourth embodiment, as shown in the sequence chart in FIG. 15, a service quality identifier which permits association and combination information between a modulation/demodulation scheme and an error correction scheme are included in a control information frame transmitted by a wireless base station 2 to a wireless terminal 1 set within a communication range of the wireless base station 2 (step S11a).

The wireless terminal 1 compares combination information between modulation/demodulation schemes and error correction schemes stored in a wireless mode storage unit 13 with the combination information between the modulation/demodulation scheme and the error correction scheme included in the control information frame transmitted by the wireless base station 2. In this manner, the wireless terminal 1 can accurately decide the possibility of association with the wireless base station 2.

The wireless terminal 1 does not transmit a wireless association request frame to the wireless base station 2 unless the combination information between the modulation/demodulation schemes and the error correction schemes stored in the wireless mode storage unit 13 is included in the control information frame (step S18). As a result, the wireless association request frame need not be transmitted in vain, and a wireless communication band can be effectively used. In addition, data transmission of another wireless terminal 1 which is connecting with the wireless base station 2 is not inhibited, and the communication quality of the wireless terminal 1 which is connecting with the wireless base station 2 can be reliably guaranteed.

In this manner, the wireless terminal 1 according to the fourth embodiment can decide whether a association request is permitted or rejected on the basis of a service quality identifier and combination information between a modulation/demodulation scheme and an error correction scheme included in a control information frame transmitted from the wireless base station 2. Because of this, a association request need not be made in vain, and a wireless communication band can be effectively used.

(Fifth Embodiment)

According to the fifth embodiment, occupancy of a wireless channel is measured in a wireless terminal 1 before a wireless association request frame is transmitted.

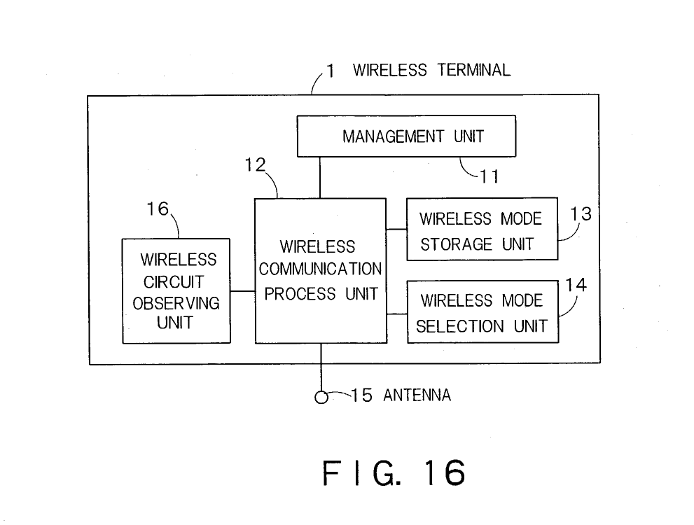

FIG. 16 is a block diagram showing the schematic configuration of the wireless terminal 1 according to the fifth embodiment. The wireless terminal 1 in FIG. 16 is obtained by adding a wireless circuit observing unit 16 to the wireless terminal 1 in FIG. 3.

The wireless circuit observing unit 16 decides whether or not a wireless circuit is busy before the wireless terminal 1 communicates with a wireless base station 2.

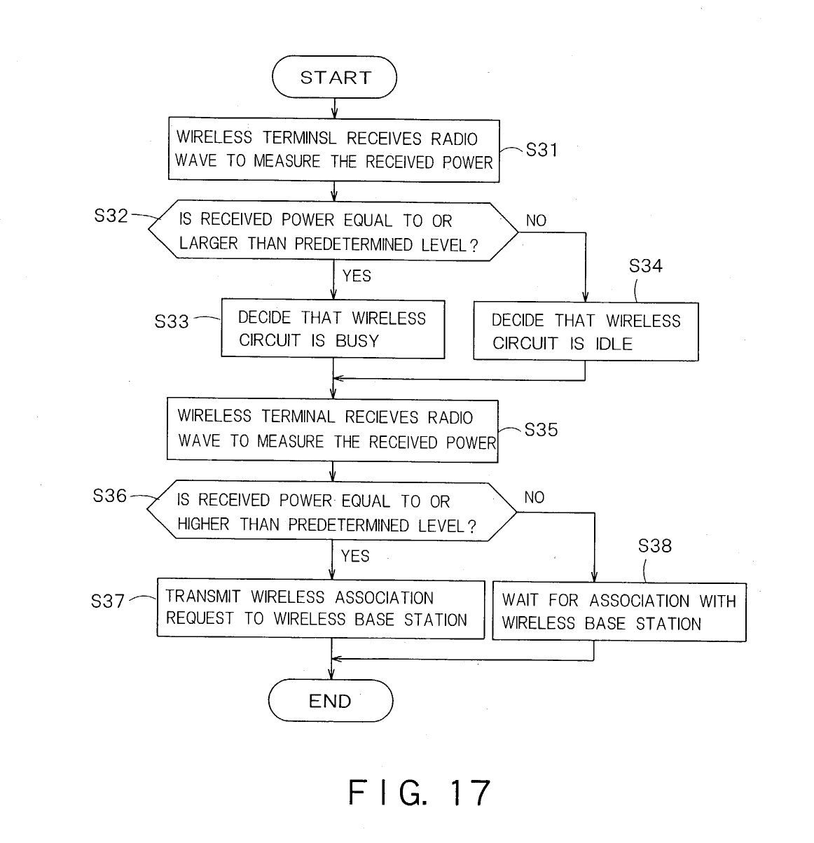

FIG. 17 is a flow chart showing an example of a procedure for measuring occupancy of a wireless channel by the wireless terminal 1. In this flow chart, a wireless communication system based on CSMA scheme such as IEEE802.11 is considered.

The wireless terminal 1 receives a radio wave to measure the received power (step S31). The wireless terminal 1 decides whether or not the measurement of the received power is equal to or higher than a predetermined level (step S32). When the measurement is equal to or higher than the predetermined level, the wireless circuit observing unit 16 decides that the wireless circuit is used, i.e., that the wireless circuit is busy (step S33). When the received power is equal to or lower than the predetermined level, the wireless circuit observing unit 16 decides that the wireless circuit is idle (step S34).

The wireless circuit calculates a ratio of a busy time to an idle time (step S35) to decide whether or not the rate of the idle time is equal to or larger than a predetermined value (step S36). When the rate of the idle time is equal to or larger than the predetermined value, the wireless terminal 1 expects that association is probably permitted when the wireless terminal 1 tries association, and the wireless terminal 1 shifts to the process of transmitting a wireless association request frame (step S37). In CSMA system, the wireless association request frame cannot be always transmitted immediately after the wireless terminal 1 shifts to the transmission process.

On the other hand, when the rate of the idle time is equal to or smaller than the predetermined value, the wireless terminal 1 expects that association is probably rejected when the wireless terminal 1 tries association, and the wireless terminal 1 does not transmit a wireless association request frame in vain (step S38). More specifically, the wireless terminal 1 does not transmit the association request frame until the rate of the idle time is equal to or larger than the predetermined value.

In this manner, according to the fifth embodiment, the wireless terminal 1 decides whether or not a wireless circuit is idle on the basis of a received power measured by the wireless terminal 1. The wireless terminal 1 makes a association request to the wireless base station 2 only when the wireless circuit is idle. Because of this, the wireless terminal may not obstruct communication of another wireless terminal 1, and communication quality which is requested by the terminal which is being associated to the wireless base station can be continuously guaranteed.

As has been described in the above embodiments, modulation schemes and error correction schemes used when IEEE802.11a is employed are mainly explained. However, the present invention, another wireless schemes (for example, IEEE802.11b, IEEE802.11g, or the like) can also be applied. Although the physical layer of the IEEE802.11g is different from that of the IEEE 802.11a, the IEEE802.11g uses the same MAC layer as that of the IEEE802.11a. Because of this, the present invention is applicable to the IEEE802.11g.

What is claimed is:

1. A wireless terminal for performing wireless communication with a wireless base station, comprising:
a wireless mode selection unit which selects all combinations between modulation/demodulation schemes and error correction schemes capable of performing wireless communication of predetermined quality with the wireless base station;
a wireless mode storage unit which stores all combination information selected by the wireless mode selection unit; and
a wireless communication process unit which transmits a specific wireless signal including all combination information between the modulation/demodulation schemes and the error correction schemes stored in the wireless mode storage unit, and a service quality identifier representing quality of a wireless communication service in the case of performing wireless communication with the wireless base station, to the wireless base station.

2. A wireless terminal according to claim 1, wherein
said wireless communication process unit transmits a wireless association request to the wireless base station when all combination information of the modulation/demodulation schemes and the error correction schemes and the service quality identifier are stored in the wireless mode storage unit.

3. A wireless terminal according to claim 1, wherein
said wireless communication process unit performs wireless communication with the wireless base station on the basis of control information including the combination information between the modulation/demodulation scheme and the error correction scheme and the service quality identifier transmitted from the wireless base station.

4. A wireless terminal according to claim 3, wherein
said wireless communication process unit receives, from the wireless base station, control information including the combination information between the modulation/demodulation scheme and the error correction scheme and said service quality identifier which guarantees communication quality between all wireless terminals associated with said wireless base station including a disassociated wireless terminal and said wireless base station, when said wireless base station permits association of the disassociated wireless terminal.

5. A wireless terminal according to claim 3, wherein
said wireless communication process unit receives the control information included in a beacon.

6. A wireless terminal according to claim 3, wherein
said wireless communication process unit receives the control information included in a association response frame transmitted by said wireless base station in order to respond to a association request from a disassociated wireless terminal.

7. A wireless terminal according to claim 3, wherein
said wireless communication process unit receives the control information included in a control information frame transmitted by said wireless base station to said wireless terminal located within a communication range of said wireless base station.

8. A wireless terminal according to claim 1, comprising:
a wireless channel observing unit which observes occupation of a wireless channel;
an occupation decision unit which decides whether a value representing the observed occupation of the wireless channel is equal to more than a predetermined threshold value; and
a time ratio calculation unit which calculates a time ratio of a time at which the occupation decision unit decides that the value representing the observed occupation of the wireless channel is equal to or more than said threshold value, to a time at which the occupation decision unit decides that the value representing the observed occupation of the wireless channel is less than said threshold value,
wherein the wireless communication process unit decides whether a wireless association request is transmitted to the wireless base station on the basis of the time ratio.

9. A wireless base station for performing wireless communication with a wireless terminal, comprising:
a wireless association terminal management unit which manages combination information between modulation/demodulation schemes and error correction scheme and a service quality identifier representing quality of a wireless communication service which are used when a wireless communication service is performed with regard to each of the wireless terminals to which association is permitted; and
an association permission/rejection decision unit which decides whether association of a disassociated wireless terminal is permitted or rejected on the basis of the combination information between the modulation/demodulation scheme and the error correction scheme and the service quality identifier, for all the wireless terminals managed by the wireless association terminal management unit, and which decides a specific combination between the modulation/demodulation scheme and the error correction scheme used when a wireless communication service is performed with regard to the disassociated wireless terminal and the service quality identifier such that the combination between the modulation/demodulation scheme and the error correction scheme and the service quality identifier of the wireless terminal which association has been permitted are not changed.

10. A wireless base station according to claim 9, wherein
said wireless association terminal management unit has a management table included in which address information for identifying said wireless terminal, said service quality identifier, and combination information between the modulation/demodulation scheme and the error correction scheme, and registered with regard to each of the wireless terminals which is in use.

11. A wireless base station according to claim 9, further comprising:
a wireless communication processing unit which receives a signal including at least a part of the combination information between modulation/demodulation schemes and error correction schemes of the wireless terminals and the service quality identifiers managed by the wireless association terminal management unit.

12. A wireless base station according to claim 8, wherein
a control information transmitting unit which transmits control information including combination information between the modulation/demodulation scheme and the error correction scheme and the service quality identifier representing conditions for communicating with a disassociated wireless terminal station.

13. A wireless base station which performs wireless communication with a wireless terminal, comprising:
a wireless association terminal management unit which manages combination information between modulation/demodulation schemes and the error correction schemes and the service quality identifier capable of using when a wireless communication service is performed with regard to the wireless terminals to which association is permitted; and
an association permission/rejection decision unit which decides whether association of a disassociated wireless terminal is permitted or rejected on the basis of the combination information between the modulation/demodulation scheme and the error correction scheme and the service quality identifier corresponding to all the wireless terminals managed by the wireless association terminal management unit, and which decides combination information between the modulation/demodulation scheme and the error correction scheme and the service quality identifier corresponding to the disassociated wireless terminal and all the wireless terminals managed by the wireless association terminal management unit.

14. A wireless base station according to claim 13, wherein
said wireless association terminal management unit has a management table included in which address information for identifying said wireless terminal, said service quality identifier, and combination information between the modulation/demodulation scheme and the error correction scheme, and registered with regard to each of the wireless terminals which is in use.

15. A wireless base station according to claim 13, wherein
the wireless base station transmits a signal including at least a part of the combination information between modulation/demodulation schemes and error correction schemes and the service quality identifiers, to at least one of said wireless terminal.

16. A wireless base station according to claim 13, wherein
said wireless base station has a control information transmission unit which transmits control information including combination information between the modulation/demodulation scheme and the error correction scheme and the service quality identifier representing conditions which communicate with a disassociated wireless terminal station.

17. A wireless communication system which performs wireless communication between a wireless base station and a wireless terminal, wherein
said wireless terminal comprises:
a wireless mode selection unit which selects all combinations between modulation/demodulation schemes and error correction schemes capable of performing wireless communication of predetermined quality with the wireless base station;
a wireless mode storage unit which stores all combination information selected by the wireless mode selection unit; and
a wireless communication process unit which transmits a specific wireless signal including all combination information between the modulation/demodulation schemes and the error correction schemes stored in said wireless mode storage unit and the service quality identifier representing the quality of a wireless communication service obtained when wireless communication with the wireless base station is performed, to the wireless base station, and
said wireless base station comprises:
a wireless association terminal management unit which manages combination information between modulation/demodulation schemes and error correction schemes and the service quality identifier which are used when a wireless communication service is performed with regard to the wireless terminals to which association is permitted; and
an association permission/rejection decision unit which decides whether association of a disassociated wireless terminal is permitted or rejected on the basis of the combination information between the modulation/demodulation scheme and the error correction scheme and the service quality identifier for all the wireless terminals managed by the wireless association terminal management unit, and which decides a specific combination between the modulation/demodulation scheme and the error correction scheme used when a wireless communication service is performed with regard to the disassociated wireless terminal and the service quality identifier such that the combination between the modulation/demodulation scheme and the error correction scheme and the service quality identifier of the wireless terminal to which association is permitted are not changed.

18. A wireless communication system which performs wireless communication between a wireless base station and a wireless terminal, wherein
said wireless terminal comprises:
a wireless mode selection unit which selects all combinations between modulation/demodulation schemes and error correction schemes capable of performing wireless communication of predetermined quality with the wireless base station;
a wireless mode storage unit which stores all combination information selected by the wireless mode selection unit; and
a wireless communication process unit which transmits a specific wireless signal including all combination information between the modulation/demodulation schemes and the error correction schemes stored in the wireless mode storage unit and a service quality identifier representing the quality of a wireless communication service obtained when wireless communication with the wireless base station is performed, to the wireless base station, and
the wireless base station comprises:
a wireless association terminal management unit which manages combination information between modulation/demodulation schemes and error correction schemes and the service quality identifier capable of using when a wireless communication service is performed with regard to the wireless terminals to which association are permitted, respectively; and
an association permission/rejection decision unit which decides whether association of a disassociated wireless terminal is permitted or rejected on the basis of the combination information between the modulation/demodulation scheme and the error correction scheme and the service quality identifier corresponding to all the wireless terminals managed by the wireless association terminal management unit, and which decides combination information between the modulation/demodulation scheme and the error correction scheme and the service quality identifier corresponding to the disassociated wireless terminal and all the managed wireless terminals.

19. A wireless communication scheme which performs wireless communication with a wireless base station, comprising:
selecting all combinations between modulation/demodulation schemes and error correction schemes which can perform wireless communication having predetermined quality with the wireless base station;
storing all the selected combination information; and
transmitting a specific wireless signal including the stored all combination information between the modulation/demodulation schemes and the error correction schemes and the service quality identifier representing the quality of a wireless communication service obtained when wireless communication with the wireless base station is performed, to the wireless base station.

20. A wireless communication scheme which performs wireless communication with a wireless terminal, comprising:
managing combination information between modulation/demodulation schemes and error correction schemes and the service quality identifier which are used when a wireless communication service is performed with regard to the wireless terminals to which association are permitted; and
deciding whether association of a disassociated wireless terminal is permitted or rejected on the basis of the combination information between the modulation/demodulation scheme and the error correction scheme and the service quality identifier corresponding to all the managed wireless terminals, and deciding a specific combination between the modulation/demodulation scheme and the error correction scheme used when a wireless communication service is performed with regard to the disassociated wireless terminal and the service quality identifier such that the combination between the modulation/demodulation scheme and the error correction scheme and the service quality identifier of the wireless terminal to which association has been permitted are not changed.

21. A wireless communication scheme which performs wireless communication with a wireless terminal, comprising:
managing combination information between modulation/demodulation schemes and error correction schemes and the service quality identifier which can be used when a wireless communication service is performed with regard to the wireless terminals to which permission are permitted, respectively; and
deciding whether association of a disassociated wireless terminal is permitted or rejected on the basis of the combination information between the modulation/demodulation scheme and the error correction scheme and the service quality identifier for all the managed wireless terminals, and deciding combination information between a modulation/demodulation scheme and an error correction scheme and the service quality identifier corresponding to the disassociated wireless terminal and all the managed wireless terminals.
